(19) United States
(12) Patent Application Publication
(10) Pub. No.: US 2006/0065174 A1
(43) Pub. Date: Mar. 30, 2006

(54) Rotary power planting device

(76) Inventor: John S. Body, Naples, FL (US)

Correspondence Address: EDWARD M. LIVINGSTON, PA, 963 TRAIL TERRACE DRIVE, NAPLES, FL, 34103, US

(21) Appl. No.: 10/951,174

(22) Filed: Sep. 27, 2004

(51) Int. Cl. A01C 11/00; A01G 23/02; A01C 1/00

(52) U.S. Cl. 111/200

(57) ABSTRACT

A power planting device comprised of a base plate (5) and a cone (4). The base plate (5) is removably fastenable to a powered landscaping tool, preferably a weed trimmer (1), and the cone (4) is removably fastenable to the base plate (5). When the base plate (5) and cone (4) are secured to a weed trimmer (1), the rotating motion of the weed trimmer (1) propels the cone (4) to spin. When a user positions the cone (4) onto the ground and turns the weed trimmer (1) on, cutting ribs (6) on the cone (4) dig into the ground, thereby creating a conically-shaped hole. Thus, the power for digging the hole comes from the weed trimmer (1), rather than the user.

### BACKGROUND OF THE INVENTION

This invention relates to planting devices, more specifically, a power planting device that is removably fastenable to a weed trimmer and allows a person to quickly and easily dig a conically-shaped hole with minimal effort.

In order to plant flower bulbs, trees or any other vegetation, a person must dig a hole for the acceptance of the bulb. It has been proven that the optimal shape of the hole should be conical so as to keep the base of the bulb above a pocket of air when the bulb is inserted into the hole because the air pocket permits the root system of the bulb to grow freely without hindrances.

However, it is both time consuming and physically tiring to dig these conically-shaped holes. Many times a person must get down on his or her hands and knees to dig a hole having such a shape using a hand spade. Other times, a person may use a spade shovel having a long handle so as to allow a person to stand while digging the hole. Although this method allows a person to stand on his or her feet, the method is still time consuming. Moreover, if the soil is particularly hard, a person must expend a considerable amount of strength and energy into digging the hole.

Additionally, a person must essentially stand over the direct area for digging in order to dig the hole. However, a person must be cautious of his or her footing if he or she wishes to dig a hole in a bed of flowers or in an area already having vegetation. A person could trample over already planted vegetation or, even worse, trip over the vegetation while trying to obtain a good stance for digging or kneeling. Thus, the need for an invention that allows a person to quickly and easily dig conically-shaped holes without requiring space directly over the digging area exists.

The present invention allows a person to quickly dig a conically-shaped hole with minimal effort by providing a power planting device that is removably fastenable to a conventional power landscaping tool, such as a weed trimmer. Because the base of the weed trimmer is located at a distance away from the handle of the weed trimmer, a person is able to dig a hole without having to stand directly over the digging location.

The relevant prior art includes the following patents:

| Patent No. | | |
|---|---|---|
| (U.S. unless stated otherwise) | Inventor | Issue Date |
| 6,340,061 | Marshall et al. | Jan. 22, 2002 |
| 4,213,504 | Schneider | Jul. 22, 1980 |
| 6,293,350 | Paolo | Sep. 25, 2001 |
| 6,032,442 | Paolo | Mar. 07, 2000 |
| 6,119,787 | Garcia | Sep. 19, 2000 |
| 2,779,259 | Kelsey | Jan. 29, 1957 |
| 3,048,161 | Roeder | Aug. 07, 1962 |
| 5,228,400 | Luke | Jul. 20, 1993 |
| 792,891 | Furbee | Jun. 20, 1905 |
| 6,615,928 | Dueitt | Sep. 09, 2003 |

### SUMMARY OF THE INVENTION

The primary object of the present invention is to provide a power planting device that quickly creates conically-shaped holes.

A further object of the present invention is to provide a power planting device that is removably fastenable to a weed trimmer.

An even further object of the present invention is to provide a power planting device that is easy to use.

Another object of the present invention is to provide a power planting device that digs through coarse dirt.

A further object of the present invention is to provide a power planting device that allows a person to dig a conically-shaped hole without having to stand directly over the digging location.

The present invention fulfills the above and other objects by providing a power planting device comprised of a base plate and a cone. The base plate is removably fastenable to a powered landscaping tool, preferably a weed trimmer, and the cone is removably fastenable to the base plate. When the base plate and cone are secured to a weed trimmer, the pivoting motion of the weed trimmer propels the cone to spin. When a user positions the cone onto the ground and turns the weed trimmer on, cutting ribs on the cone dig into the ground, thereby creating a conically-shaped hole. Thus, the power for digging the hole comes from the weed trimmer, rather than the user.

The use of the present invention will allow users to quickly and easily dig conically-shaped holes for planting bulbs.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective view of the present invention installed on a weed trimmer;

FIG. 2 is a downward perspective view of a cone of the present invention;

FIG. 3 is a top view of a top of a base plate of the present invention;

FIG. 4 is a downward perspective view of a bottom of the base plate of the present invention;

FIG. 5 is a side plan view of the embodiment of FIG. 1; and

FIG. 6 is a cross-sectional view along line 6-6 of the embodiment of FIG. 5.

### DESCRIPTION OF THE PREFERRED EMBODIMENTS

For purposes of describing the preferred embodiment, the terminology used in reference to the numbered components in the drawings is as follows:

| | |
|---|---|
| 1. | weed trimmer |
| 2. | handle |
| 3. | engine |
| 4. | cone |
| 5. | base plate |
| 6. | cutting rib |
| 7. | tip |
| 8. | hub |
| 9. | screw |
| 10. | tab slot |
| 11. | fitting |
| 12. | hole |
| 13. | spacer |
| 14. | center hole |
| 15. | top of base plate |
| 16. | leg |
| 17. | indentation |
| 18. | bottom of base plate |
| 19. | nut |
| 20. | rotating axis of weed |
| | trimmer |
| 21. | raised band |
| 22. | cone inner surface |
| 23. | cone outer surface |
| 24. | washer |

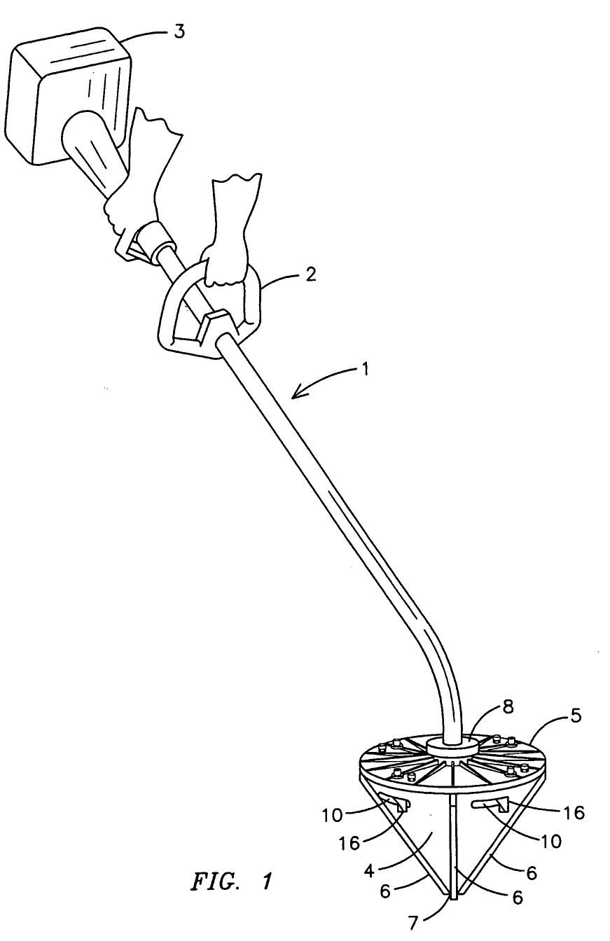

Referring to FIG. 1, a perspective view of the present invention installed on a weed trimmer 1 is shown. The present invention is installed on a powered landscaping device, preferably a weed trimmer 1 having at least a handle 2 and an engine 3, to maximize the effects of the invention. The present invention is comprised of a base plate 5 and a hollow cone 4 wherein the base plate 5 is removably fastenable to the hub 8 of the weed trimmer 1 and the cone is removably fastenable to the base plate 5. Legs 16 on the base plate 5 are inserted into tab slots 10 on the cone 4 to secure the cone 4 to the base plate 5. Cutting ribs 6 run along a length of the cone 4 and end at a tip 7 for digging into the ground. The cone 4 and the base plate 5 are preferably made of a nylon material so as to prevent corrosion.

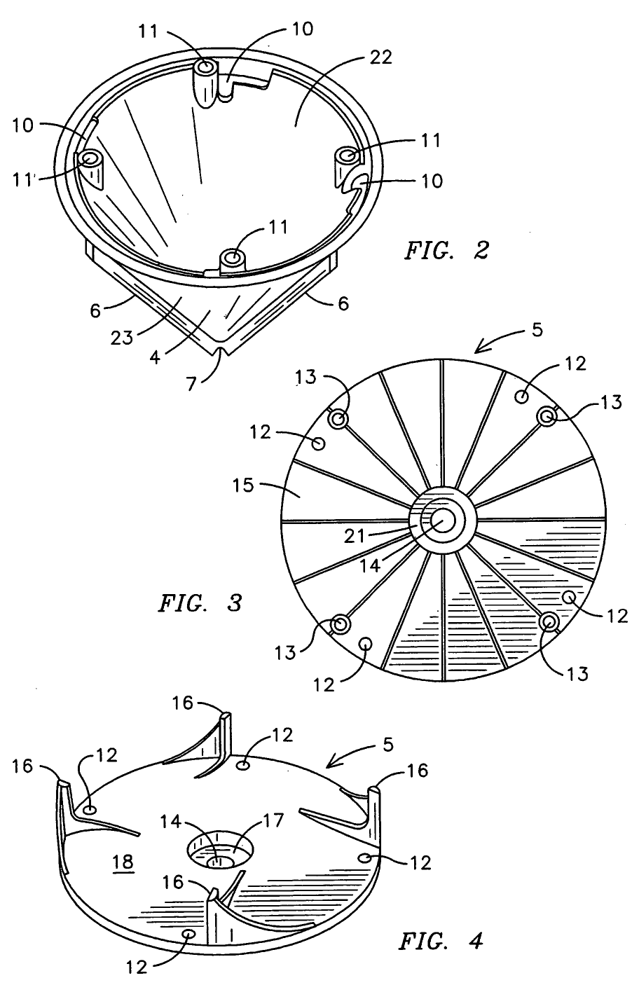

With reference to FIG. 2, a downward perspective view of the cone 4 of the present invention is shown. The cone 4 has an inner surface 22 and an outer surface 23. The cutting ribs 6 are located on the outer surface 23 of the cone 4. Fittings 11 are located on the inner surface 22 of the cone 4 and are preferably threaded so as to accommodate a preferably threaded fastener. Tab slots 10 are also located on the cone 4.

In FIG. 3, a top view of a top of a base plate 15 of the present invention is shown. The base plate 5 has holes 12 for the accommodation of fastening devices, such as screws, and spacers 13. The base plate 5 also has a center hole 14 and a raised band 21.

In FIG. 4, a bottom view of the base plate 18 of the present invention is shown. The base plate 5 has extending legs 16 spaced apart at a predetermined interval along the circumference of the base plate 5. Additionally, there is an indentation 17 located in the center of the base plate so as to position the center hole 14 in a parallel plane with the base plate 5.

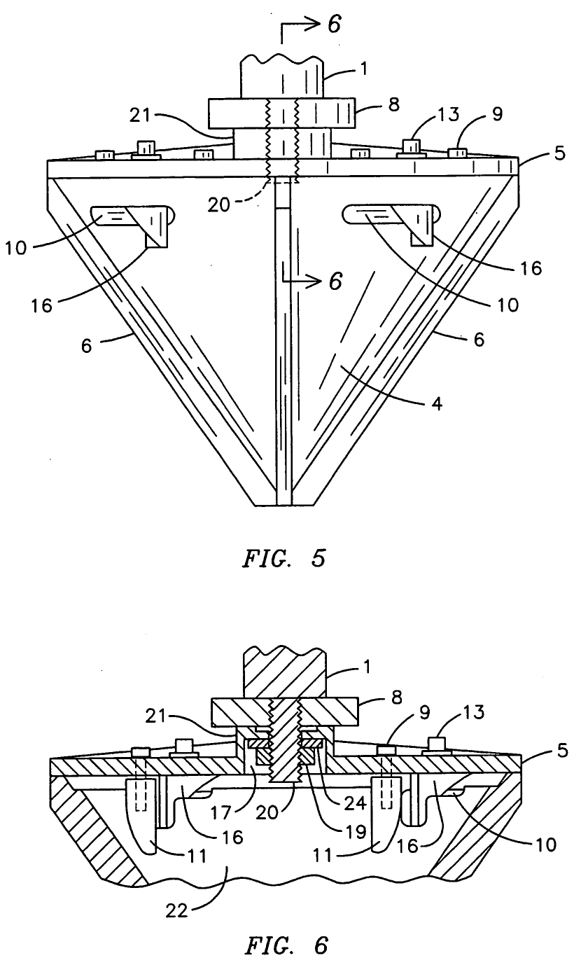

Referring to FIG. 5, a side plan view of the embodiment of FIG. 1 is shown. The raised band 21 creates a slight distance between the base plate 5 and the hub 8 of the weed trimmer 1 such that the device is not flush against the weed trimmer 1. Although it is preferable to have this distance, it is not required. The rotating axis of the weed trimmer 20 is located in the center of the weed trimmer 1 and feeds through the raised portion 21 of the base plate 5.

Finally, in FIG. 6, a cross-sectional view along line 6-6 of the embodiment of FIG. 5 is shown. The rotating axis of the weed trimmer 20 fits through the raised portion 21 and exits through the indentation 17. The base plate 5 is secured to the weed trimmer 1 by securing a nut 19 and a washer 24 to the end of the rotating axis 20 on the hub 8 of the weed trimmer 1. The legs 16 of the base plate 5 are positioned within the tab slots 10 of the cone 4 and screws 9 are inserted through the base plate 5 and into fittings 11 of the cone 4.

To install the present invention on a weed trimmer 1, a person simply removes the head from the weed trimmer 1 (not shown). Then, the user positions the base plate 5 such that the rotating axis of the weed trimmer 20 is aligned with the center hole 14 and pushes the base plate 5 upwards until the raised band 21 is against the hub 8. Now that the rotating axis of the weed trimmer is housed within the indentation 17, a washer 24 and nut 19 are

Next, the user positions the cone 4 such that tab slots 10 of the cone 4 are aligned with the legs 16 of the base plate 5 and snaps the cone 4 onto the base plate 5. Screws 9 are then inserted through holes 12 on the base plate 5 and are tightened such that the screws 9 are secured within the fittings 11 on the cone 4.

To use the present invention, a user positions the tip 7 of the cone 4 against the portion of the ground in which he or she would like to dig a planting hole. Then, the user simply powers the weed trimmer 1 so as to make the cone 4 spin. Because the rotating axis of the weed trimmer 20 is attached to the base plate 5 and cone 4, when the rotating axis of the weed trimmer 20 spins, so does the cone 4. Additionally, an optional shield may be placed on the weed trimmer 1 so as to block debris from flying up when in use.

The use of the present invention allows a user to quickly and easily dig a conically-shaped hole with minimal time and labor. Because the present invention is installed on a weed trimmer 1, a person need not stand directly over the location of the desired hole in order to dig it.

Although only a few embodiments of the present invention have been described in detail hereinabove, all improvements and modifications to this invention within the scope or equivalents of the claims are included as part of this invention.

1. A planting device for attachment to a rotary power weed trimmer, said device comprising:
a base plate removably fastenable to the rotary power weed trimmer;
a cone removably fastenable to said base plate;
at least one cutting rib located on said cone; and
a means for fastening said cone to said base plate.

2. The planting device of claim 1 wherein:
said base plate has at least one leg.

3. The planting device of claim 1 wherein:
said base plate has a centrally located hole for removably fastening said base plate to the rotary power weed trimmer.

4. The planting device of claim 1 wherein:
said base plate has at least one hole for the accommodation of said means for fastening said base plate to said cone.

5. The planting device of claim 2 wherein:
said base plate has at least one hole for the accommodation of said means for fastening said base plate to said cone.

6. The planting device of claim 3 wherein:
said base plate has at least one hole for the accommodation of said means for fastening said base plate to said cone.

7. (canceled)

8. The planting device of claim 1 wherein:
said cone has at least one tab slot.

9. The planting device of claim 1 wherein:
said cone has at least one fitting for the accommodation of said means for fastening said cone to said base plate.

10. The planting device of claim 1 wherein:
said means for fastening is at least one screw.

11. The planting device of claim 1 wherein:
said means for fastening is at least one bolt.

12. The planting device of claim 9 wherein:
said means for fastening is at least one screw.

13. The planting device of claim 9 wherein:
said means for fastening is at least one bolt.

14. The planting device of claim 9 wherein:
said at least one fitting is threaded.
